(19) United States
(12) Patent Application Publication
(10) Pub. No.: US 2015/0219134 A1
(43) Pub. Date: Aug. 6, 2015

(54) SCREW FASTENING STRUCTURE

(71) Applicant: CANON KABUSHIKI KAISHA, Tokyo (JP)

(72) Inventor: Yoshimasu Yamaguchi, Kawasaki-shi (JP)

(73) Assignee: CANON KABUSHIKI KAISHA, Tokyo (JP)

(21) Appl. No.: 14/422,482

(22) PCT Filed: Sep. 11, 2013
(86) PCT No.: PCT/JP2013/075215

§ 371 Date: Feb. 19, 2015

(30) Foreign Application Priority Data
Sep. 26, 2012 (JP) 2012-212150

(51) Int. Cl. F16B 9/02

(52) U.S. Cl. CPC F16B 9/026

(57) ABSTRACT

Provided is a screw fastening structure for fastening a shoulder screw to a thin metal plate member (114). Half-punched portions (141 to 144) are formed radially from a center of a through hole (115) in the thin plate member (114) by half punching so as to be alternately recessed and protruded in a circumferential direction. Further, a threaded portion (133) is formed by tapping in the through hole (115) provided at substantially the center position of the half-punched portions. Then, a member to be fastened (102) is fastened to the thin plate member (114) with a screw.

### TECHNICAL FIELD

The present invention relates to a screw fastening field of a screw hole for fastening a screw to a metal plate therethrough, and more particularly, to a screw fastening structure that uses a technology of subjecting a metal member to burring in which half punching is performed around a screw hole for reinforcement of a screw.

### BACKGROUND ART

Hitherto, there has been generally known a structure of fixing, with a screw, to a plate member serving as a fastening member made of a metal material, a member to be fastened that is made of a metal plate member similar to the plate member described above or a resin material. In particular, even when the plate member serving as the fastening member is as thin as about 1 mm, it is necessary to reliably fix the member to be fastened to the fastening member with a screw for a thin plate. Therefore, there is known a method of subjecting a screw hole portion of the fastening member to burring to secure the screw hole body height, thereby further increasing a screw fastening force at the abutment position of the thread as compared to the case where the fastening member is merely subjected to piercing.

PTL 1 proposes a structure using burring in a tap prepared hole. The structure has a feature as follows. An inner peripheral surface in the vicinity of the leading end part of the tap prepared hole in which a thread is formed by plastic deformation is inwardly protruded to form an inner pressure increasing part, and the inner diameter of the inner pressure increasing part is set smaller than the inner diameter of the tap prepared hole. With such a technical structure, the percentage of thread engagement in the effective thread can be 100%, and thus the tightening torque can be increased and the strength of the threaded portion can be increased as compared to the conventional method.

So-called hemming that involves inwardly bending the outer shape end portion by 180° is also generally known. With this, the strength of the thin plate member serving as the fastening member can be secured. Moreover, it is possible to prevent a worker who processes the thin plate member, a worker for transportation or packing, a worker who assembles the product into which the processed product is to be incorporated, the product user, and the like from touching burrs formed on the outer shape portion of the product obtained by processing the thin plate member.

The following structure has also been proposed. That is, the thin metal plate is subjected to burring in the vicinity of the outer periphery thereof, and the end portion is further subjected to hemming. Further, a hole through which the outer periphery of the part subjected to burring is inserted is provided. In this manner, the screw fastening portion is formed to have a double metal plate structure.

PTL 2 discloses the following burring method as solving means for reducing the processing cost and the number of processing steps and for improving the efficiency. Hitherto, burring other than small diameter pierce burring, such as one for forming a screw prepared hole, has been performed in two steps. In a drawing and punching burring punch with a preliminary drawing part, in which the burring method described above is performed in one step, there are features reside in the shape of the drawing and punching burring punch with the preliminary drawing part and in a drawing and punching step with the preliminary drawing part.

Further, as in PTL 3, the following method is known, which is invented for the purpose of providing a structure that does not require a so-called workpiece holding mechanism such as a pad and a stripper on the presumption that the forming of an embossed portion and the piercing are performed in one step.

That is, a lower die including a button die having a die hole formed therein and an upper die including a pierce punch cooperate to form, in a panel, an embossed portion and a pierce hole at a part corresponding to the embossed portion in one step. At this time, based on an operation of lowering the upper die, a pierce hole is formed in a preceding manner due to the shearing action between the pierce punch and the die hole. Following the forming of the pierce hole, surfaces for embossment of the lower die and the upper die pressurize and restrict a portion around a pierce hole P to form the embossed portion.

On the other hand, as commercial special screws, there are known shoulder screws. Of those, CROWN SCREW CORPORATION provides a shoulder screw having no incomplete thread under the product name of “SHOLDEK” (trademark).

As in PTL 1, in order to inwardly protrude the inner peripheral surface in the vicinity of the leading end part of the tap prepared hole to form the inner pressure increasing part, and set the inner diameter of the inner pressure increasing part smaller than the inner diameter of the tap prepared hole, a specific processing method is necessary, and thus the number of steps for the processing may be increased.

Burring is performed for the purpose of increasing the number of the abutment positions of the thread as much as possible in order to secure the screw fastening force. It is therefore necessary to increase the burring height. Thus, the thickness between the burring inner diameter portion and the burring outer shape portion is inevitably reduced. This thickness is set on the premise that the thinned part is not damaged through screwing. Therefore, as the fastening member becomes thinner, the thickness formed between the burring inner diameter portion and the burring outer shape portion cannot be sufficiently secured, with the result that the thinned part may be damaged by the screw and a sufficient fastening force cannot be generated.

Further, when burring is performed, a round clearance shape is generated at the root of the drawn portion, and hence a bearing surface that can sufficiently receive the step of the shoulder screw cannot be secured in some cases. When the diameter of a shoulder portion is increased to address this problem, the entire screw portion is increased in size, which causes a problem in that the entire apparatus may be increased in size.

PTL 2 is superior in the point that burring can be performed in one step. However, a round shape is formed at the bending circumference portion of the burring, and hence, similarly to PTL 1, when the shoulder screw is used, it is necessary to be aware that the bearing surface is set with a margin.

PTL 3 is superior in terms of achieving the emboss formation and the pierce hole formation in one process. Further, the pierce hole can be subjected to tapping, and the embossed portion can be used for reinforcement. However, when the plate is thin, there arise such problems in that, because the plate is thin, the screw to be fastened easily falls and the engagement amount of the screw is small, which leads to insufficient strength and easy breakage. In this case, necessary fastening torque may not be obtained.

In a case of the shoulder screw, there has been a risk in that, when the screw is fastened to a thin plate, due to the incomplete thread generated at the root of the threaded portion extending from the shoulder portion, accurate screw fastening may not be performed and fastening failure may be caused due to breakage or damage of the threaded portion. Therefore, there is provided a screw having no incomplete thread, as the one in the conventional example.

### CITATION LIST

### Patent Literature

PTL 1: Japanese Patent Application Laid-Open No. H10-026359
PTL 2: Japanese Patent Application Laid-Open No. H09-164431

### PTL 3: Japanese Patent Application Laid-Open No. 2009-214151

### PTL 4: Japanese Patent Application Laid-Open No. 2010-48308

### SUMMARY OF INVENTION

### Solution to Problem

The present invention has been made to solve the problems in the above-mentioned related art, and provides screw-fastening burring means for a screw fastening structure, which is capable of obtaining a sufficient screw fastening force without causing deformation and breakage in a base member.

A representative screw fastening structure according to one embodiment of the present invention includes: a plate member serving as a fastening member; a screw hole portion provided in the plate member, the screw hole portion having a helical portion on an inner surface thereof to fasten a screw; and a recessed portion obtained by subjecting a periphery of the screw hole portion to half punching so that the inner surface of the screw hole portion has a stepped portion in a thickness direction of the plate member.

Another screw fastening structure according to one embodiment of the present invention includes: a plate member serving as a fastening member; a screw hole portion provided in the plate member, the screw hole portion having a helical portion on an inner surface thereof to fasten a screw; and a recessed portion formed in a circumferential direction of the screw hole portion so that parts of an inner peripheral portion of the screw hole portion are formed at different positions in a thickness direction of the plate member.

Further features of the present invention will become apparent from the following description of exemplary embodiments with reference to the attached drawings.

### BRIEF DESCRIPTION OF DRAWINGS

FIG. 1 is a schematic cross-section view illustrating the simple structure of an example of an image forming apparatus.

FIG. 2A is a schematic view of a part of an ITB unit.

FIG. 2B is a schematic view of a part of an ITB unit.

FIG. 3 is a perspective view of a part of the ITB unit.

FIG. 4A is a rear-side plan view illustrating half-pierce burring performed on a thin plate member.

FIG. 4B is a side view illustrating the half-pierce burring performed on the thin plate member.

FIG. 4C is a front-side plan view illustrating the half-pierce burring performed on the thin plate member.

FIG. 5A is a front-side perspective view illustrating the half-pierce burring performed on the thin plate member.

FIG. 5B is a rear-side perspective view illustrating the half-pierce burring performed on the thin plate member.

FIG. 6 is a partially cut-out side view illustrating a commercial shoulder screw having no incomplete thread.

FIG. 7 is a partially cut-out side view illustrating a shoulder screw having an incomplete thread.

FIG. 8 is a cross-section view illustrating the shape of a threaded portion in the thin plate member.

FIG. 9A is a plan view illustrating a partial structure of the ITB unit in a comparative embodiment.

FIG. 9B is a cross-section view illustrating the partial structure of the ITB unit in the comparative embodiment.

FIG. 9C is a rear view illustrating the partial structure of the ITB unit in the comparative embodiment.

FIG. 10 is an enlarged cross-section view illustrating a part of the ITB unit in the comparative embodiment.

FIG. 11A is a plan view illustrating a part of an ITB unit of an image forming apparatus, which illustrates half-pierce burring according to a first embodiment of the present invention.

FIG. 11B is a cross-section view illustrating the part of the ITB unit of the image forming apparatus, which illustrates the half-pierce burring according to the first embodiment.

FIG. 11C is a rear view illustrating the part of the ITB unit of the image forming apparatus, which illustrates the half-pierce burring according to the first embodiment.

FIG. 11D is a cross-section view illustrating the part of the ITB unit of the image forming apparatus, which illustrates the half-pierce burring according to the first embodiment.

FIG. 12 is an enlarged cross-section view illustrating a part of the ITB unit of the image forming apparatus, which illustrates the half-pierce burring according to the first embodiment.

FIG. 13A is an enlarged perspective view of a front part of the ITB unit of the image forming apparatus, which illustrates the half-pierce burring according to the first embodiment.

FIG. 13B is an enlarged perspective view of a rear part of the ITB unit of the image forming apparatus, which illustrates the half-pierce burring according to the first embodiment.

FIG. 14A is a plan view illustrating a part of an ITB unit of an image forming apparatus, which illustrates half-pierce burring according to a second embodiment of the present invention.

FIG. 14B is a cross-section view illustrating the part of the ITB unit of the image forming apparatus, which illustrates the half-pierce burring according to the second embodiment.

FIG. 15 is an enlarged perspective view illustrating a part of the ITB unit of the image forming apparatus, which illustrates the half-pierce burring according to the second embodiment of the present invention.

FIG. 16A is a plan view illustrating a part of an ITB unit of an image forming apparatus, which illustrates half-pierce burring according to a third embodiment of the present invention.

FIG. 16B is a cross-section view illustrating the part of the ITB unit of the image forming apparatus, which illustrates the half-pierce burring according to the third embodiment.

FIG. 17A is a plan view illustrating a part of an ITB unit of an image forming apparatus, which illustrates half-pierce burring according to a fourth embodiment of the present invention.

FIG. 17B is a cross-section view illustrating the part of the ITB unit of the image forming apparatus, which illustrates the half-pierce burring according to the fourth embodiment.

FIG. 18 is an enlarged perspective view illustrating a part of the ITB unit of the image forming apparatus, which illustrates the half-pierce burring according to the fourth embodiment.

FIG. 19A is a plan view illustrating a part of an ITB unit of an image forming apparatus, which illustrates half-pierce burring according to a fifth embodiment of the present invention.

FIG. 19B is a cross-section view illustrating the part of the ITB unit of the image forming apparatus, which illustrates the half-pierce burring according to the fifth embodiment.

FIG. 20 is an enlarged perspective view illustrating a part of the ITB unit of the image forming apparatus, which illustrates the half-pierce burring according to the fifth embodiment.

### DESCRIPTION OF EMBODIMENTS

Now, embodiments of the present invention are described with reference to the accompanying drawings.

### First Embodiment

### (1) Description of Example of Image Forming Apparatus

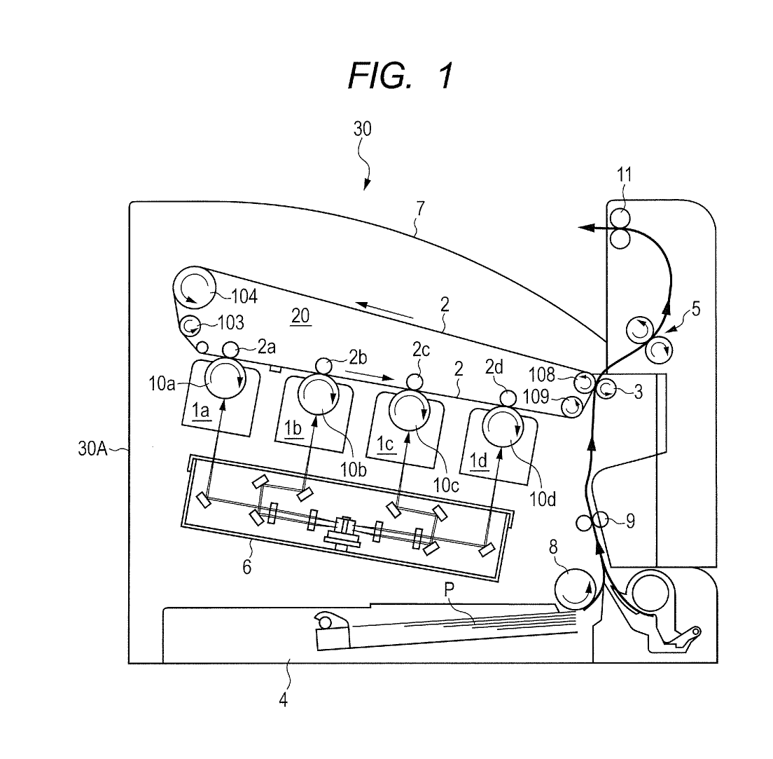

FIG. 1 is a schematic view illustrating the overall structure of an image forming apparatus 30 according to an embodiment of the present invention. First, an image forming process is described. FIG. 1 is merely an example for description, and the present invention is not limited thereto.

The image forming apparatus 30 of FIG. 1 is a four-color (full-color) intermediate transfer type electrophotographic image forming apparatus. At a center part of an image forming apparatus main body 30A, there are arranged, in a tandem manner, four (first to fourth) electrophotographic photosensitive drums 10a to 10d for forming toner images of respective colors of yellow (Y), magenta (M), cyan (C), and black (K) in the order from the left side to the right side in FIG. 1.

Around each of those electrophotographic photosensitive drums (hereinafter referred to as “drums”) 10a to 10d, there is arranged an electrophotographic image formation process unit such as a charging device, a developing device, and a cleaner (not shown). The respective drums and process units that act thereon are formed into units as process cartridges (hereinafter referred to as “cartridges”) 1a to 1d that are removably mounted to the image forming apparatus main body 30A.

On the upper side of those cartridges 1a to 1d, an intermediate transfer belt unit (ITB unit) 20 is arranged. This unit 20 includes multiple rollers 103, 104, 108, and 109 that are arranged at a unit frame. An image transfer belt or intermediate transfer belt (ITB) 2 is looped and tensioned (stretched) around those rollers.

A lower surface of a lower half belt part of the ITB 2 is brought into contact with upper surfaces of the respective drums 10a to 10d. On the inner side of the ITB 2, four primary transfer rollers 2a to 2d are arranged so as to be opposed to and brought into abutment against the upper surfaces of the respective drums 10a to 10d across the ITB 2.

The drums 10a to 10d are rotationally driven at a predetermined circumferential speed in the clockwise direction as represented by arrows, and are uniformly charged at a predetermined polarity and potential by the charging devices. Then, the drums 10a to 10d are exposed to light of images of respective separated colors of Y, M, C, and K from an exposure device 6. With this, latent images (electrostatic images) corresponding to a Y-color component image, an M-color component image, a C-color component image, and a K-color component image of a color image are respectively formed on the drums 10a to 10d. The respective latent images are developed by the developing devices, and toner images of Y color, M color, C color, and K color are respectively formed on the drums 10a to 10d.

The ITB 2 is rotationally driven at a circumferential speed substantially equal to the circumferential speed of the drums 10a to 10d in a counterclockwise direction as represented by arrows (forward direction with respect to the rotation of the drum 10). Along with the rotation of the drums 10a to 10d, the toner images arrive at primary transfer portions at which the drums 10a to 10d are brought into abutment against the ITB 2. The toner images are sequentially transferred onto the moving ITB 2 in an overlapping manner by the primary transfer rollers 2a to 2d. That is, a four-color (Y color, M color, C color and K color) overlapping toner image is formed on the ITB 2. A predetermined primary transfer bias is applied from an electric component board (not shown) to the primary transfer rollers 2a to 2d.

Sheets P that are recording media (recording materials) stored in a feeding cassette 4 are sent one by one by a pick-up roller 8. After the timing is adjusted by registration rollers 9, the sheet P is conveyed to a secondary transfer nip portion formed of a secondary transfer roller 3 and the ITB 2, to thereby collectively secondarily transfer the four-color overlapping toner image on the ITB 2 to the sheet P.

After that, the sheet P having the toner image transferred thereon is conveyed to a fixing device 5 where the toner image receives heat and pressure to be fixed. With this, the toner of respective colors is melted and mixed to form a full-color print image fixed to the sheet P. The sheet P exiting from the fixing device 5 is delivered on a delivery tray 7 by a delivery conveyance unit 11 provided on the downstream in a sheet conveyance direction with respect to the fixing device 5.

Arrangement of the respective portions inside the image forming apparatus main body 30A is described. In the image forming apparatus 30 according to this embodiment, the feeding cassette 4, the exposure device 6, the cartridges 1a to 1d, the ITB unit 20, and the delivery tray 7 are arranged in this order from the lower side of the image forming apparatus main body 30A.

### (2) ITB Unit 20

Such image forming apparatus has many functions, and hence a large number of various components are provided. Further, improvement of positional accuracy between the various components and reduction of vibration, distortion, and the like of the apparatus main body are demanded at a higher level. Therefore, measures to improve strength and dimensional accuracy or the like are demanded at a higher level for the frame structure of the image forming apparatus 30 as well.

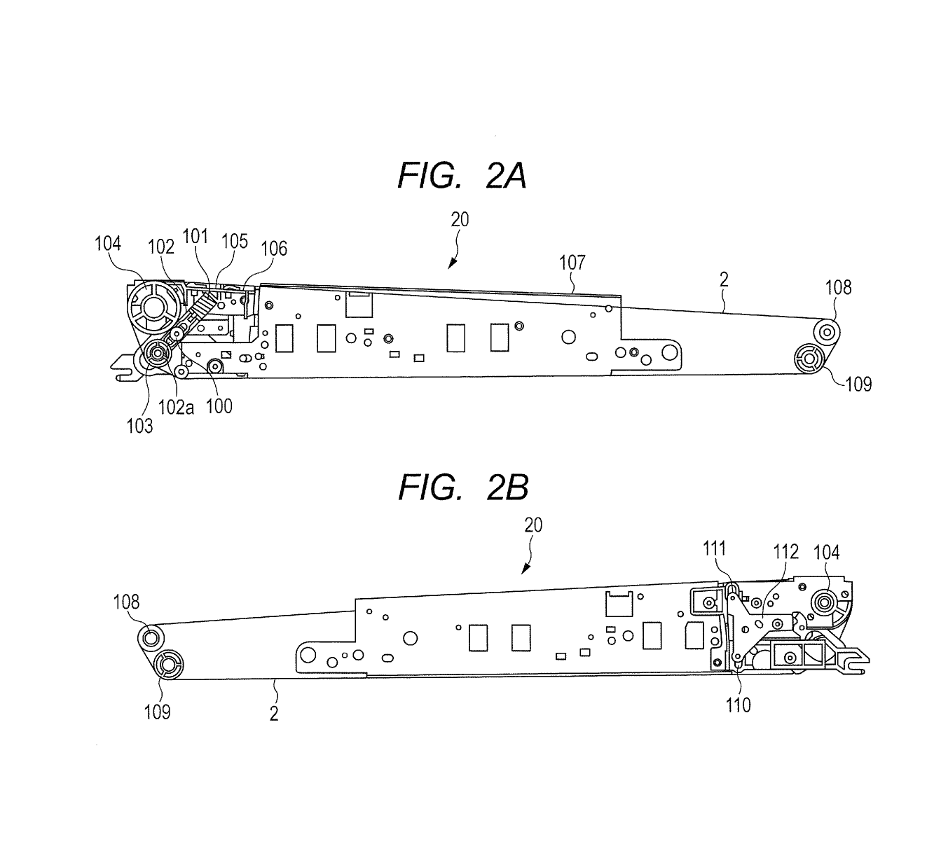

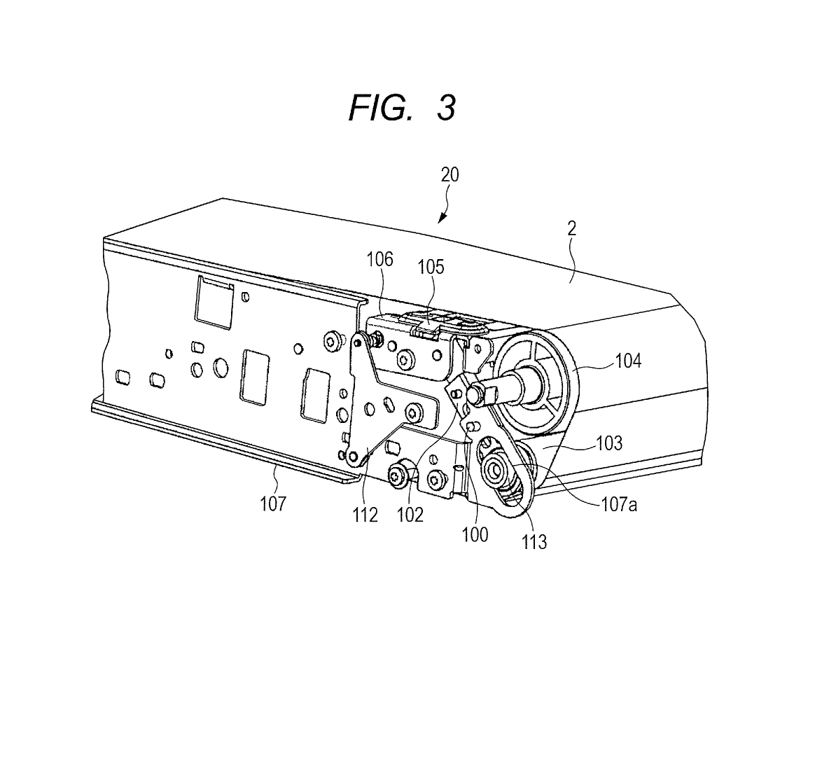

FIG. 2A is a schematic view of a side surface part of the ITB unit 20 on one end side in the belt width direction (on the near side in FIG. 1), and FIG. 2B is a schematic view of a side surface part thereof on the other end side (far side). FIG. 3 is a perspective view of a part of the ITB unit 20.

The ITB unit 20 of FIGS. 1 to 3 includes a shoulder screw 100, a compression spring 101, a tension roller bushing 102, a guide slot hole 102a, a tension roller 103, and a drive roller 104. Further, FIGS. 1 to 3 illustrate a tension holder 105, a transfer drive stay 106, a transfer rear side plate 107, a transfer rear side plate guide hole 107a, a secondary transfer opposing roller 108, an idler roller 109, a transfer arm slot hole 110, and a transfer arm slot hole 111. FIGS. 1 to 3 further illustrate a steering slide bearing plate 112 and a tension slider roller 113.

In FIGS. 1 and 2A, the drive roller 104 and the tension roller 103 are arranged on the left side of the ITB unit 20, and the secondary transfer opposing roller 108 and the idler roller 109 are arranged on the right side thereof. The axial directions of the respective rollers are substantially parallel to each other, and the axial direction is a direction perpendicular to the drawing sheet of FIG. 1. The ITB 2 is stretched around those rollers. The secondary transfer roller 3 is brought into pressure-contact with the secondary transfer opposing roller 108 across the ITB 2 by a biasing unit (not shown) at a predetermined pressing force. The pressure-contact portion between the ITB 2 and the secondary transfer roller 3 corresponds to the secondary transfer nip portion.

In response to driving input to the drive roller 104, the ITB 2 circulates and moves in accordance with a defined image formation speed in the counterclockwise direction represented by the arrows in FIG. 1. The tension roller 103, the secondary transfer opposing roller 108, the idler roller 109, and the primary transfer rollers 2a to 2d are rotated in association with the circulating movement of the ITB 2. The idler roller 109 is rotated in association therewith while securing a one-end position of the ITB 2.

The tension roller 103 applies tension to the ITB 2, and controls the belt skew of the ITB 2 in the cylindrical direction by steering due to use of an inclination angle. A steering is mounted to the transfer rear side plate 107 serving as a part of a basic frame of the ITB unit 20, and is configured to swing by the transfer arm slot holes 110 and 111 for guiding the steering slide bearing plate.

The transfer drive stay 106 and the tension holder 105 are held by and fixed to the transfer rear side plate 107. The tension roller bushing 102 has a slot hole at a center portion thereof, and the shoulder screw 100 relating to this embodiment of the present invention is fitted therein so that the tension roller bushing 102 is fastened to the transfer rear side plate 107 with the screw. In this embodiment, the transfer rear side plate 107 is a thin plate member serving as a fastening member made of a metal material, and the tension roller bushing 102 is a member to be fastened, which is fastened to the transfer rear side plate 107 with a screw.

The compression spring 101 is arranged on one end portion of the tension roller bushing 102, and is brought into abutment against the tension holder 105. The tension roller 103 is mounted to the other end portion of the tension roller bushing 102 in a manner that the tension roller 103 is rotatably supported by the tension slider roller 113. The tension roller 103 is guided through the transfer rear side plate guide hole 107a, and biases so as to be movable in the spring biasing direction. Thus the tension roller 103 applies tension to the ITB 2 from the inner side.

The ITB 2 is gradually deteriorated as the copying of sheets is repeated in the long-term use due to contact wear caused by, for example, a belt cleaning unit and developer from a developing unit. The ITB 2 is a consumable component that is required to be replaced after copying of several hundreds of thousands of sheets. Therefore, a serviceman for repair and maintenance performs the replacement operation. At this time, for the purpose of loosening the stretched belt, the pressure of the tension roller 103 is released. In some cases, the entire steering unit is removed. In this case, the following operation is repeated. That is, the shoulder screw 100 is loosened to be disengaged, and after the replacement, the shoulder screw 100 is fastened again.

If this screw 100 is damaged, it becomes necessary to replace a larger number of components such as the frame, and hence the cost increases. Therefore, it is necessary to obtain a structure with a margin, in which the threaded portion is firmly fastened.

However, on the other hand, in order to meet demands for, for example, reduction in size, weight, and cost of the apparatus, the need for fully utilizing a thin plate member formed of an electrolytic zinc-coated steel sheet has been demanded for such as the frame including the transfer rear side plate 107. Therefore, a SECC-SD (cold-rolled steel sheet subjected to zinc plating) member having a thickness of 1.2 mm has been used for a shoulder screw portion of the transfer rear side plate 107 of this structure, and an M3 thread has been formed therein.

The M3 thread, that is, a metric coarse thread has a thread lead pitch of 0.5 mm, and hence a lead of two rotations can be obtained. Thus, a necessary fastening force of 0.6 N·m (6 kgf·cm) and fastening torque can be obtained, and hence it has been considered that there are no adverse effects for use. However, in a case of a usage condition in which fastening and disengaging are repeated for maintenance, further improvement in reliability is demanded.

### (3) Half-Pierce Burring

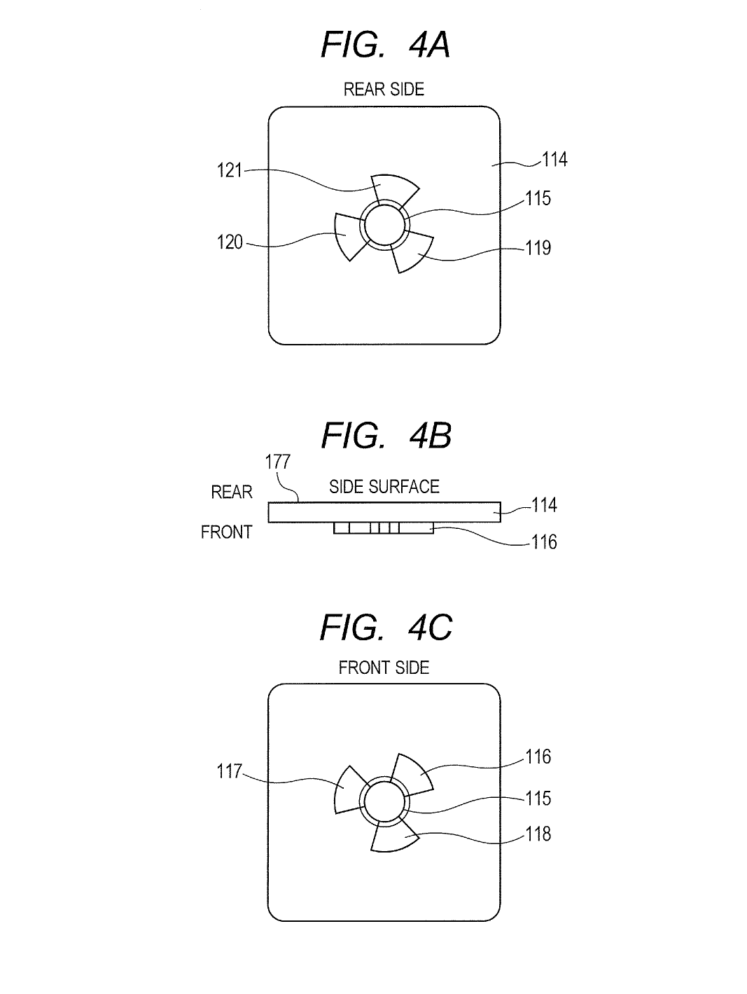

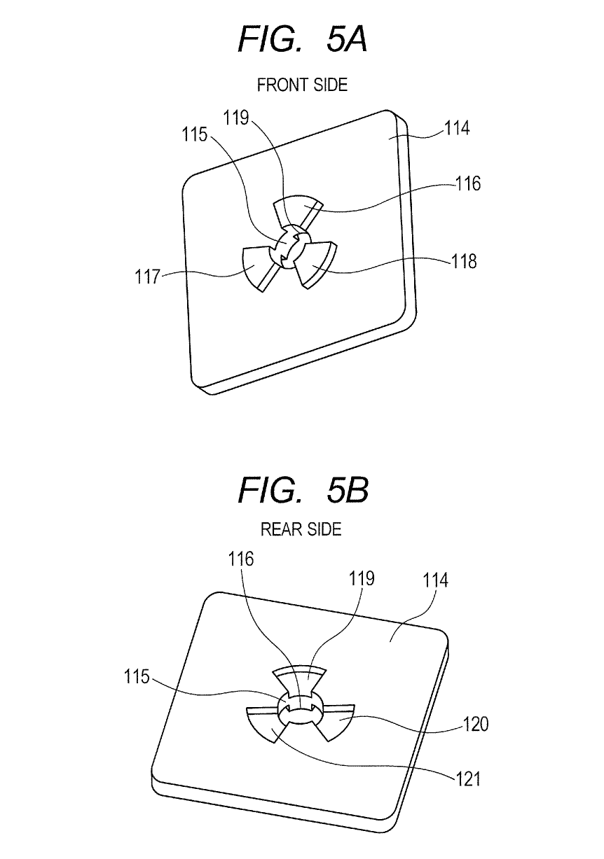

FIGS. 4A, 4B, 4C, 5A, and 5B illustrate half-pierce burring corresponding to burring accompanying with a half-punched shape according to this embodiment of the present invention (hereinafter referred to as “half-pierce burring”). FIGS. 4A, 4B, and 4C are plan views and a side view illustrating the half-pierce burring performed on the thin plate member. Further, FIGS. 5A and 5B are a front-side perspective view and a rear-side perspective view illustrating the half-pierce burring performed on the thin plate member. FIGS. 4A, 4B, 4C, 5A, and 5B omit the outer shape of the thin plate member and schematically illustrate the thin plate member as a rectangular member to represent the shape of the half-pierce burring.

“Half-pierce” refers to formation of a step by stopping a die in the middle of the plate thickness so as not to pierce the metal plate over the entire thickness unlike punching. Further, “burring” refers to a pressing process that involves drawing a part of the thin plate into a hole shape to form a burr-like protrusion on the rear surface.

FIGS. 4A, 4B, 4C, 5A, and 5B illustrate a thin plate member 114 and a screw hole 115. The thin plate member 114 includes, on the front side thereof, a first half-punch protruding portion 116, a second half-punch protruding portion 117, and a third half-punch protruding portion 118. The thin plate member 114 includes, on the rear side thereof, a first half-punch recessed portion 119, a second half-punch recessed portion 120, and a third half-punch recessed portion 121.

The M3 screw hole 115 is provided at the center portion of the thin plate member 114 that is the zinc plated steel sheet (SECC-SD) having a thickness of 1.2 mm. When a cutting tap is used, the inner diameter is set to φ2.459 mm. When self-tapping or rolled tapping is used for processing, a prepared hole dimension is set to φ2.78 mm. Around the screw hole, recesses and protrusions (half-punched shape) are formed by dividing the circumference of the screw hole into three equal parts.

The expression “half punching” refers to processing of punching the plate to the half of its thickness by using a shear force with a die set of a press machine, and stopping the punching in the middle of the thickness due to plastic deformation. Generally, in press punching processing, there are known a processing method that involves punching out the material so that the material is separated, and a processing method that involves integrally forming a step by stopping the die in the middle of the thickness without fully punching out the material. The latter method is referred to as “half punching”.

The die set is a unit component including a punch holder, a die holder, a guide post, and a guide bushing. The thin plate member 114 is sandwiched between the punch and the die mounted to the die set. Note that, in the actual case, it is unnecessary to stop the punching accurately at the middle of the thickness, and the shift amount of the plastic deformation of the half-punched shape can be arbitrarily set depending on the usage application and purpose. This setting is generally performed.

The uneven surface of the thin plate member 114 is formed by press half punching due to shearing, and hence the first half-punch recessed portion 119 and the first half-punch protruding portion 116 correspond to each other and one is protruded to the extent that the other is recessed. The volume of the half-punched part does not vary due to pressing. Similarly, the second half-punch recessed portion 120 and the second half-punch protruding portion 117 correspond to each other, and the third half-punch recessed portion 121 and the third half-punch protruding portion 118 match with each other.

Metal plate pressing is generally performed by a die set called a single die. In the first step, the prepared hole (through hole) serving as the screw hole 115 is punched out by a punch press. Next, in the second step, the half-punch portions are formed by half-punching pressing so as to be arranged equiangularly. In the final third step, the prepared hole is subjected to tapping by using a forming tap or a cutting tap with a tapping machine to complete the metal plate pressing.

However, if the number of processing steps increases, the cost increases accordingly. In order to obtain the same processing shape without increasing the number of processing steps, as disclosed in the conventional example of PTL 3, it is also possible to perform forming of the embossed part and the pierce hole in one process.

By using a progressive die, as disclosed in PTL 4, it is possible to perform tapping inside the press die with use of a forming tap. With this, it is possible to provide half-pierce burring in a reduced processing time for pressing while preventing the cost increase.

In a classification of the press die, the progressive die is classified into a single die, a progressive die, and a transfer die. The progressive die has a structure in which dies are arranged for respective processing steps in the material feeding direction, and each step is set as one frame so that the material is sequentially fed (passed on) in each frame. The respective dies for the multiple steps are arranged in order at regular pitches inside the single die. The progressive die refers to a die system or the die itself, in which one rotation of the flywheel of the press machine causes one press and one stroke, and which passes one pitch by a feeding device for each one rotation to pass on the material to the next step.

### (4) Shoulder Screw

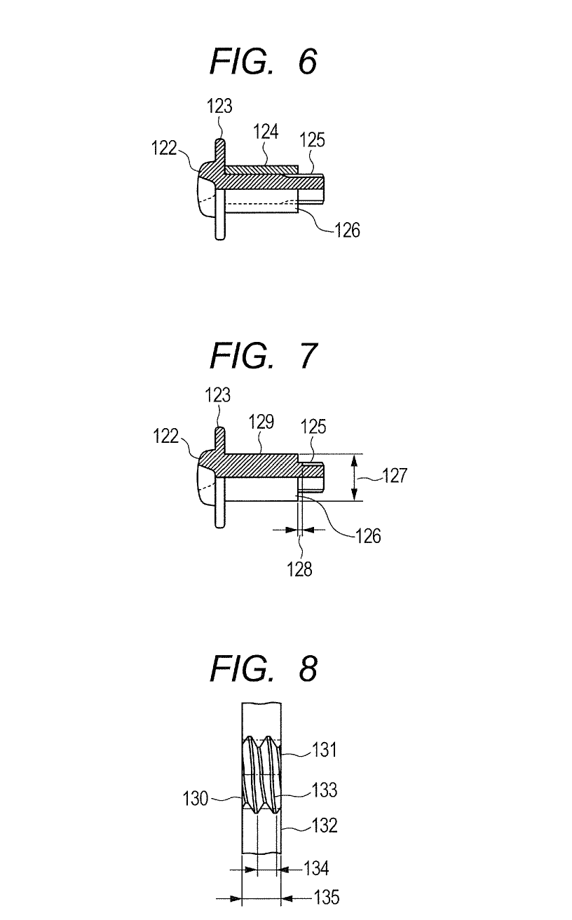

FIGS. 6 and 7 illustrate the structure of the shoulder screw. FIG. 6 illustrates a side view and a partial cross-section view of a commercial shoulder screw having no incomplete thread, which is adopted in the present invention. FIG. 7 illustrates a side view and a partial cross-section view of a shoulder screw having an incomplete thread.

Usually, a general screw has a shape divided into a head portion and a threaded portion. The shoulder screw refers to a screw having a structure in which a straight columnar portion that is slightly smaller in diameter than the head portion is provided, and the threaded portion is arranged below the straight columnar portion.

FIG. 6 is a shoulder screw having no incomplete thread, which is named “SHOLDEK” (trademark) distributed by CROWN SCREW CORPORATION. “SHOLDEK” has a simple structure in which a standard spacer is combined to a normal washer-faced machine screw in a manner that the spacer does not slip out, and thus “SHOLDEK” can be produced inexpensively. Further, as the material of the machine screw, low carbon steel (12C) is subjected to annealing, and the shoulder portion collar 124 is subjected to carburized quenching, to thereby improve the strength.

In the shoulder screw, a flange 123 is formed so as to extend from a peripheral side edge of a screw head 122 to secure a wide planar portion. In a threaded portion 125 serving as a stem portion, a shoulder portion collar 124 serving as the spacer forms a shoulder portion. The end portion of the shoulder portion collar 124 forms an abutment bearing surface 126, and the threaded portion 125 is formed further on the deeper side with respect to the abutment bearing surface 126. Thus, an accurate thread can be formed down to the root of the shoulder portion collar 124. There is also a lineup employing, as the threaded portion, a self-tapping thread instead of the metric coarse thread.

FIG. 7 is a conventional generally-used shoulder screw. A Phillips-head screwdriver bit hole is formed in the screw head 122. Similarly to FIG. 6, the flange 123 is extended in a planar state. A shoulder portion 129 is integrally formed by heading or component rolling while maintaining a shoulder portion diameter 127. Even when threading is performed with use of rolling dies or cutting dies, an incomplete thread is left at the root portion of the threaded portion 125 that extends from the abutment bearing surface 126. The incomplete thread has a length of about one and a half times the general thread pitch, and hence, in the case of an M3 thread, the incomplete thread is 0.75 mm. Therefore, normal screw fastening cannot be performed in this part.

Therefore, when this screw is applied to a thin plate member of the thickness of 1.2 mm, the dimension of the screw that is actually fastened in the thickness direction is 0.45 mm.

FIG. 8 is a cross-section view illustrating the crest and root shape of a threaded portion 133, which illustrates the shape of a thread formed in a thin plate member 132 having a thickness dimension 135 of 1.2 mm. There is a tolerance in the thickness dimension, which is 1.2 mm±0.1 mm in conformity to Japanese Industrial Standards (JIS). JIS is the industrial standards developed based on the Industrial Standardization Law, following the report recommendations by the Japanese Industrial Standards Committee and establishment by the competent minister, and is also one of the national standards of Japan.

As illustrated in FIG. 8, a thread lead pitch 134 of the metric coarse thread M3 is 0.5 mm. A metric thread can be classified into a coarse thread and a fine thread, and the metric coarse thread is employed unless a specific notation is made. M3 represents a metric thread having a thread crest outer diameter of φ3 mm.

A sufficient strength as a thread cannot be obtained in a first incompletely threaded portion 130 and a second incompletely threaded portion 131 because a profile of a thread formed through helical threading with respect to a plane forms a knife edged shape in a range of 0.25 mm on each side.

As described above, the plate has a minimum thickness dimension of 1.1 mm, which is obtained by subtracting the tolerance 0.1 mm from the thickness 1.2 mm. When the screw is fastened thereto, excluding 0.25 mm of the incompletely threaded portion on a side that has a significant influence in the fastening direction, 0.85 mm of the plate can maintain the thread strength as a complete threaded portion.

However, in general, in order to obtain a sufficient screw fastening strength, a lead length of 2.5 threads is necessary. Therefore, the complete thread forming portion of 1.25 mm is necessary. In order to obtain a sufficient screw fastening strength, 1.6 mm is the appropriate value for the thickness dimension 135 of the thin plate member 132.

In the case of the shoulder screw having an incomplete thread 128, which is generally used and described with reference to FIG. 7, the lead pitch (P) is 0.5 mm×1.5 in the case of the M3 thread. Therefore, the incomplete thread is 0.75 mm, which is further added to 1.6 mm corresponding to the appropriate value for the thickness to become 2.35 mm. In order to prevent the increase of the thickness as the calculated value obtained by the calculation described above, the shoulder screw having no incomplete thread as illustrated in FIG. 6 is applied, to thereby achieve reduction in weight of the thin plate and great cost reduction.

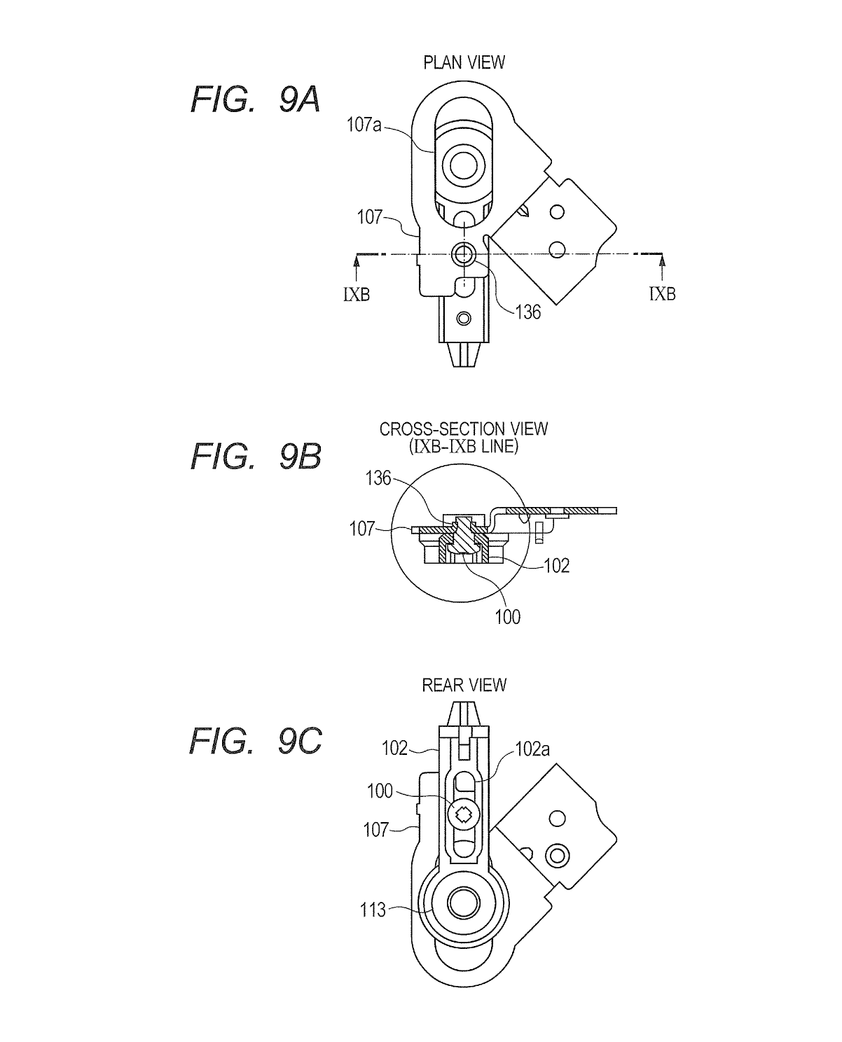

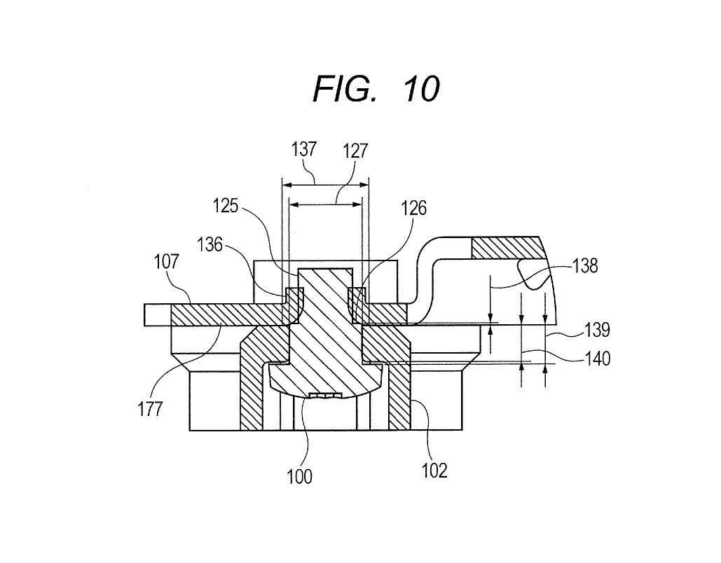

FIGS. 9A, 9B, 9C, and 10 are views illustrating details of a part of the ITB unit 20 illustrated in FIGS. 1 to 3 in a comparative embodiment. FIGS. 9A, 9B, and 9C are a plan view, a cross-section view, and a rear view of the part of the ITB unit of the image forming apparatus in the comparative embodiment according to the present invention. FIG. 10 is an enlarged cross-section view of the part of the ITB unit of the image forming apparatus in the comparative embodiment according to the present invention.

FIGS. 9A, 9B, 9C, and 10 illustrate the shoulder screw 100, the tension roller bushing 102 serving as the member to be fastened, the guide slot hole 102a, the transfer rear side plate (thin plate member) 107 serving as the fastening member, the transfer rear side plate guide hole 107a, and the tension slider roller 113. FIGS. 9A, 9B, 9C, and 10 further illustrate the abutment bearing surface 126, the shoulder portion diameter 127, a burring 136, a burring drawing droop range dimension 137, a dropping amount 138, a dimension 140 of a tension roller bushing guide portion, and a shoulder portion height 139.

The transfer rear side plate 107 is provided with the transfer rear side plate guide hole and the burring 136, and the tension roller bushing 102 and the tension slider roller 113 are held thereto by the shoulder screw 100 in a slidable manner. At this time, the shoulder portion diameter 127 of the shoulder screw 100 is set so that the shoulder portion may move smoothly and accurately in a slide-fitting manner in the guide slot hole 102a provided in the tension roller bushing 102.

As illustrated in FIG. 10, the burring 136 requires a surface of the transfer rear side plate 107 that abuts against the abutment bearing surface 126 having the shoulder portion diameter 127 of the shoulder screw 100. However, in the range represented by the burring drawing droop range dimension 137 of the burring 136, a round shape is formed by bending and drawing. Therefore, the shoulder screw 100 has its shoulder portion height reduced by the dropping amount 138.

That is, as the shoulder portion height 139 is reduced, there is a fear in that the dimension for transition fitting to loose fitting, which corresponds to the fitting dimension, is set smaller, and hence the movement is inhibited to obstruct the slide-fitting. In particular, when the screw is repeatedly fastened and disengaged, the edge of the shoulder portion and the drawing round-shape part are brought into line contact or point contact, and hence abrasion and flaw generation are promoted due to the strong fastening force. Accordingly, there has been a fear in that the movement of the tension roller bushing 102 is further inhibited.

### (5) Solution to Problems

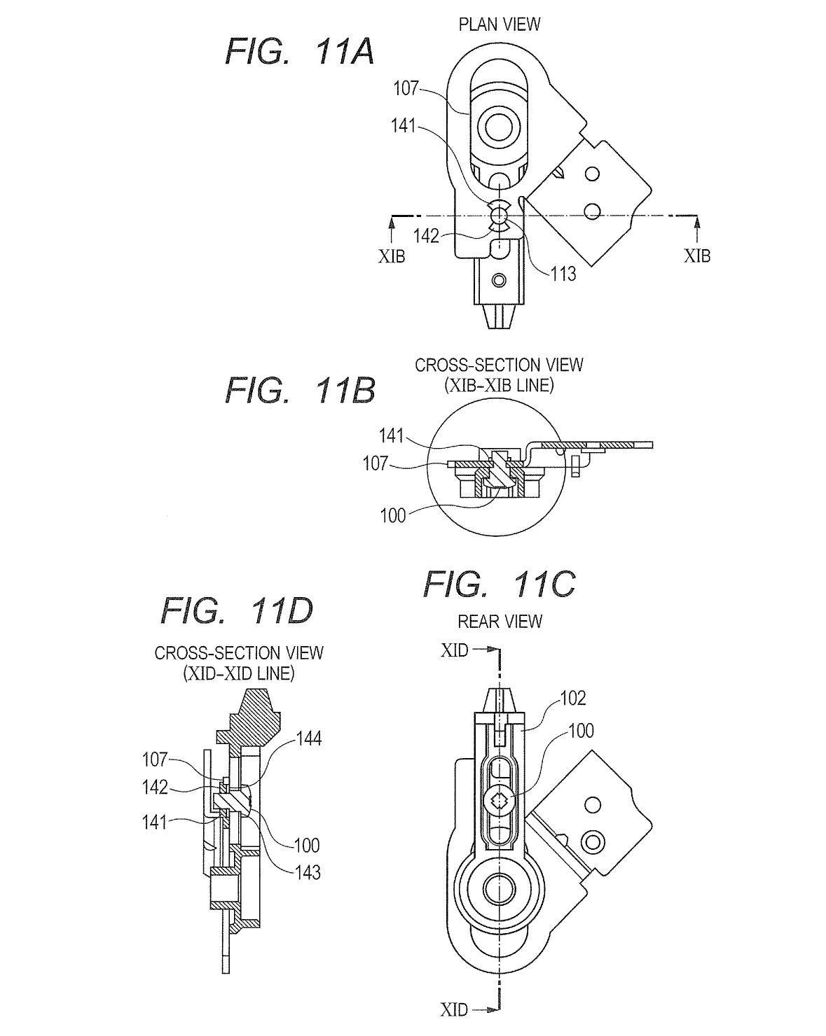

The shoulder screw 100 has unique problems as described above, and hence when the shoulder screw 100 is used, sufficient consideration is necessary in design. In the following, with reference to FIGS. 11A to 20, embodiments of the present invention are sequentially described so as to propose a structure for solving the problems described above in the conventional examples, and the details of the structure are described.

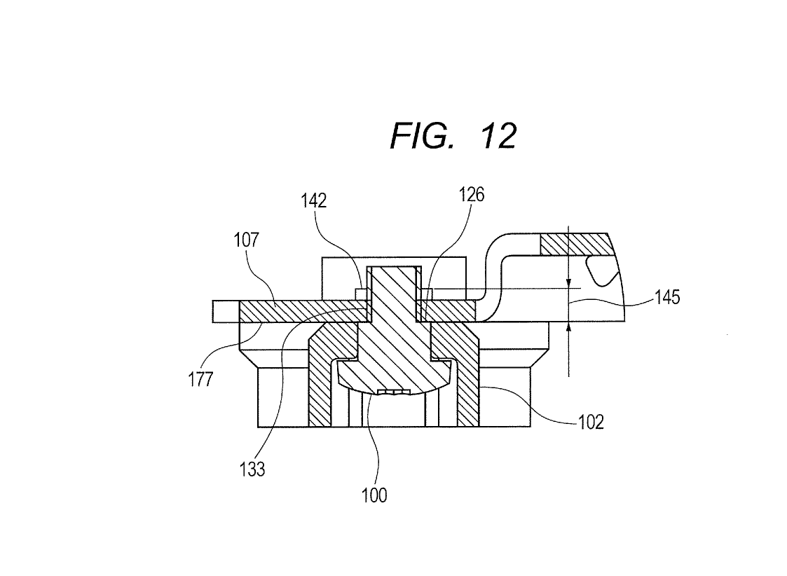

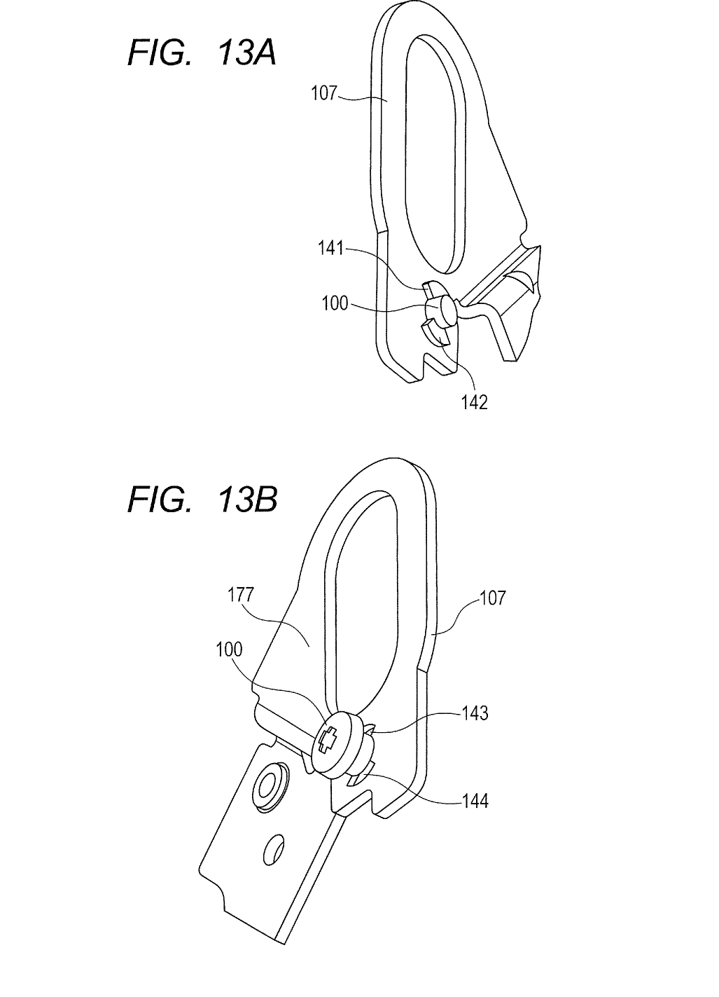

FIGS. 11A to 13B illustrate a first embodiment of the present invention. FIGS. 11A, 11B, 11C, and 11D are a plan view, a cross-section view, a rear view, and a cross-section view illustrating a part the ITB unit of the image forming apparatus, which illustrate the half-pierce burring according to the first embodiment. FIG. 12 is an enlarged cross-section view illustrating a part of the ITB unit of the image forming apparatus, which illustrates the half-pierce burring according to the first embodiment. FIGS. 13A and 13B are enlarged perspective views of front and rear parts of the ITB unit of the image forming apparatus, which illustrate the half-pierce burring according to the first embodiment.

FIGS. 11A to 13B illustrate the shoulder screw 100, the tension roller bushing 102 serving as the member to be fastened, and the transfer rear side plate (thin plate member) 107 serving as the fastening member. Stepped portions 141, 142, 143, and 144 are radially formed from the center of the through hole in the transfer rear side plate 107 by half punching so as to be alternately recessed and protruded in the circumferential direction. In the through hole, the threaded portion 133 is formed by tapping. For the sake of easy understanding of the description, the portions and components that are the same as those of the comparative embodiment illustrated in FIGS. 9A to 10 are represented by the same reference symbols and names.

The first embodiment represents a structure of fastening the shoulder screw 100 to the transfer rear side plate 107 that is a thin plate member serving as the fastening member made of a metal material. The stepped portions having a burring height dimension 145 are formed by half punching and round hole piercing in the transfer rear side plate 107 radially from the center of the circular screw hole (through hole) 115 so as to be alternately recessed and protruded in the circumferential direction. The first half-punch protruding portion 141, the second half-punch protruding portion 142, the first half-punch recessed portion 143, and the second half-punch recessed portion 144 are formed, and the threaded portion 133 is formed by tapping in the screw hole 115 provided at the substantially center position of the half-punched shape.

The threaded portion 133 is formed by cutting tap processing, forming tap processing, or self-tapping screw processing.

In the structure, the tension roller bushing 102 serving as the member to be fastened is fastened to the transfer rear side plate 107 that is the thin plate member with the shoulder screw 100. In particular, in the first embodiment, a shoulder screw having no incomplete thread is used, the half-punched shape is formed in two directions from the screw hole as the center, and a thread is formed from a planer surface portion so that the abutment bearing surface reliably abuts against the planer surface. In addition, half-pierce burring that increases the thickness to one and a half times the plate thickness is employed. Thus, this embodiment has features in that the length of the complete threaded portion is increased, and the screw fastening force is increased.

The half-punched portion is formed into a round shape around the screw hole 115 as the center, and is formed in an area that is equal to or larger than the diameter of the shoulder portion of the shoulder screw.

When the shoulder screw 100 is fastened to the transfer rear side plate 107 that is the thin metal plate member serving as the fastening member, the tension roller bushing 102 serving as the member to be fastened is fitted and fastened to the shoulder portion 129 of the shoulder screw 100.

In the structure of fastening the tension roller bushing 102 serving as the member to be fastened to the thin plate member 107 with a screw in a movable manner, the first half-punch protruding portion 141 and the second half-punch protruding portion 142 are protruded in one direction corresponding to the direction of the protruding portion of the half punching. The shoulder screw 100 is inserted from the half-punch recessed side of the first half-punch recessed portion 143 and the second half-punch recessed portion 144, which is opposite to the protruding side (half-punch recessed side on the opposite side), and fastened.

The inlet of a screw inserting portion for the member to be fastened of the transfer rear side plate 107, which is the thin plate member that abuts against the abutment bearing surface 126 of the screw 100, and a vertical virtual surface of the screw form a substantially edged ridge line of an edge. Under this state, the screw is fastened to the half-pierce burring portion of the transfer rear side plate 107 that is the thin plate member.

The half-punched shape may be formed into a rectangular shape so as to increase the effective length of the female thread at this location and increase the fastening force. In this case, the male screw as the counterpart may have a small incomplete thread at the root. This embodiment is merely an example, and there are other effective methods to reduce the incomplete thread, such as addition of a washer and addition of a thin processing undercut at the root of the screw. As described above, by forming the vicinity of the female threaded portion into a half-punched shape as in this case, there is provided a basic form for improving the fastening force.

### Second Embodiment

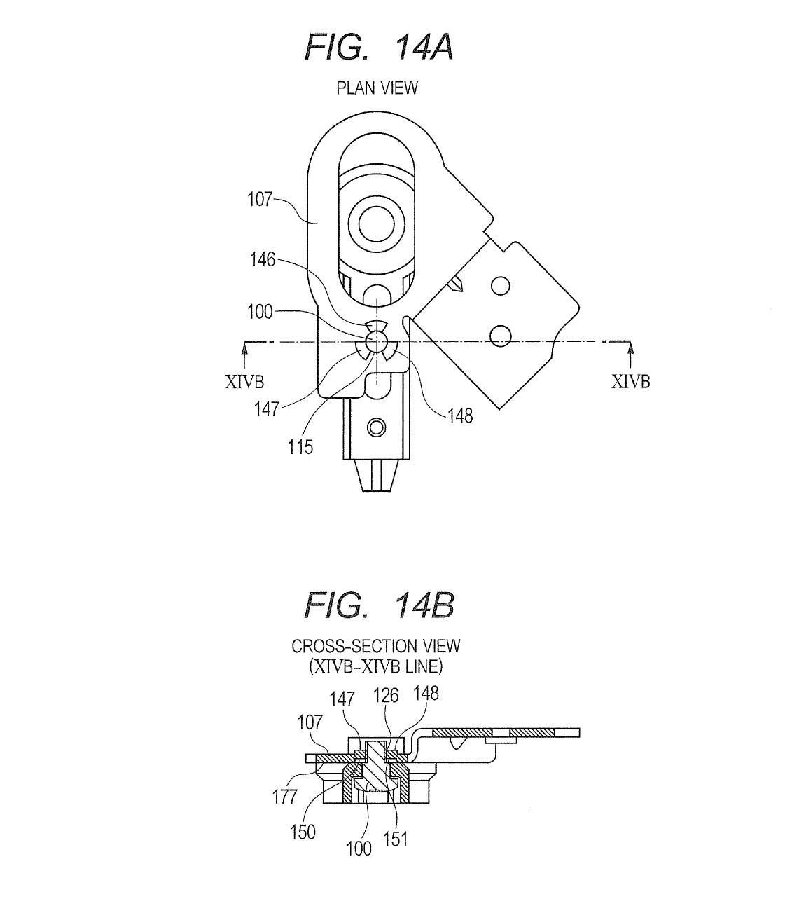

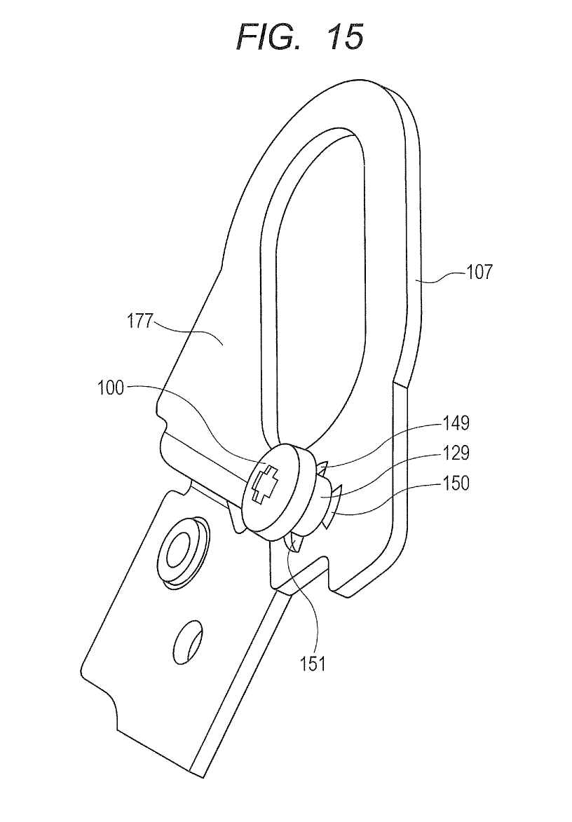

FIGS. 14A, 14B, and 15 illustrate a different shape of the half-pierce burring which is obtained by improving the first embodiment for further stable fastening. The shape is described in detail with reference to FIGS. 14A, 14B, and 15 which illustrate the half-pierce burring.

FIGS. 14A and 14B are a plan view and a cross-section view of a part of the ITB unit of the image forming apparatus, which illustrate half-pierce burring according to a second embodiment of the present invention. FIG. 15 is an enlarged perspective view of a rear part of the ITB unit of the image forming apparatus, which illustrates the half-pierce burring according to the second embodiment.

In FIGS. 14A, 14B, and 15, as the shoulder screw 100 is fastened from a screw fastening-side plane 177 of the transfer rear side plate 107, three portions of the screw fastening-side plane abut against the inner side with respect to the shoulder portion diameter 127, and the shoulder screw 100 is tightened. The recessed and protruding shape is formed with respect to the screw hole 115 so as to be equiangularly divided into three parts, and hence when the screw is fastened, the chance of start of the engagement between the thread of the male screw and the root of the female thread increases. Therefore, the easiness of mounting relating to the screw fastening is improved.

Further, the shape is equiangularly provided in three directions, and hence the stress and load to be applied to the abutment bearing surface 126 of the shoulder screw 100 can be distributed in a balanced manner, and hence it is possible to prevent deformation of the thin plate member, which is usually liable to elastically deform.

The second embodiment employs half-pierce burring that provides the recessed and protruding shape having three half-punched recessed shapes (protruding shapes) which are divided, and each protrusions and recesses has a central angle of 60° which is obtained by dividing the entire circumference into six equal parts. That is, the half-pierce burring includes front surface-side protruding shapes including a first half-punch protruding portion 146, a second half-punch protruding portion 147, and a third half-punch protruding portion 148, and rear surface-side recessed shapes including a first half-punch recessed portion 149, a second half-punch recessed portion 150, and a third half-punch recessed portion 151, which correspond to the protruding shapes, respectively.

However, the present invention is not limited to the above-mentioned angle. An arbitrary fastening strength can be set based on the form of the different screws, such as a metric fine thread or a tapping screw. An arbitrary fastening strength can be set based on the required fastening force, for example, 0.6 N·m to 1.2 N·m in the case of a general metric coarse thread.

An arbitrary fastening strength can be set based on the strength of the material itself of the thin plate member to be used, such as a high tensile strength steel sheet, or, for example, an aluminum sheet that is different from a cold-reduced carbon steel sheet such as SPCC and SECC. SPCC is rolled steel for general structure. SECC is an electrolytic zinc-coated steel sheet, which is one of surface treated steel sheets.

In a case of a screw used in a location where the screw is repeatedly fastened and disengaged, or a case of a screw to which a spring biasing force is applied, the thread is easily damaged, and hence measures are taken to increase the lead engagement amount of the thread.

In the case of a metric coarse thread, when a SECC-SD member is used, burring is generally performed when the plate has a thickness in a range of 0.6 mm to 1.6 mm to deal with the above-mentioned problem, but the present invention can similarly deal with the above-mentioned problem by employing the half-pierce burring.

The material marks of SPCC-SD are defined in JIS (G3141) “Cold-reduced Carbon Steel Sheets and Strips” (see JIS handbook, Ferrous Materials & Metallurgy). Three types of cold-reduced carbon steel sheet are defined, that is, SPCC (commercial quality), SPCD (drawing quality), and SPCE (deep drawing quality). Marks indicating the heat treatment state and the surface state of the material are postfixed. The marks indicating the heat treatment state and the surface state of the material are defined as a thermal refining classification and a surface finishing classification as shown in a table.

In sheet metal pressing, burring is generally performed in two steps, that is, a prepared hole piercing step and a burring and drawing step. However, as described above, the half-pierce burring can be formed in one step, and hence it is possible to obtain such an effect of reduction in number of dies and in manufacturing time period.

Further, even when the plate has a thickness in the range of 0.4 mm to 0.6 mm, an effect equivalent to that in a case of press thickening can be obtained. Therefore, the strength of the uneven shape including the half-punched portions increases to prevent screw falling and bearing surface deformation. Further, the total screw engagement height increases, and hence it is possible to obtain a tilting prevention effect, such as easiness in erecting the screw.

### Third Embodiment

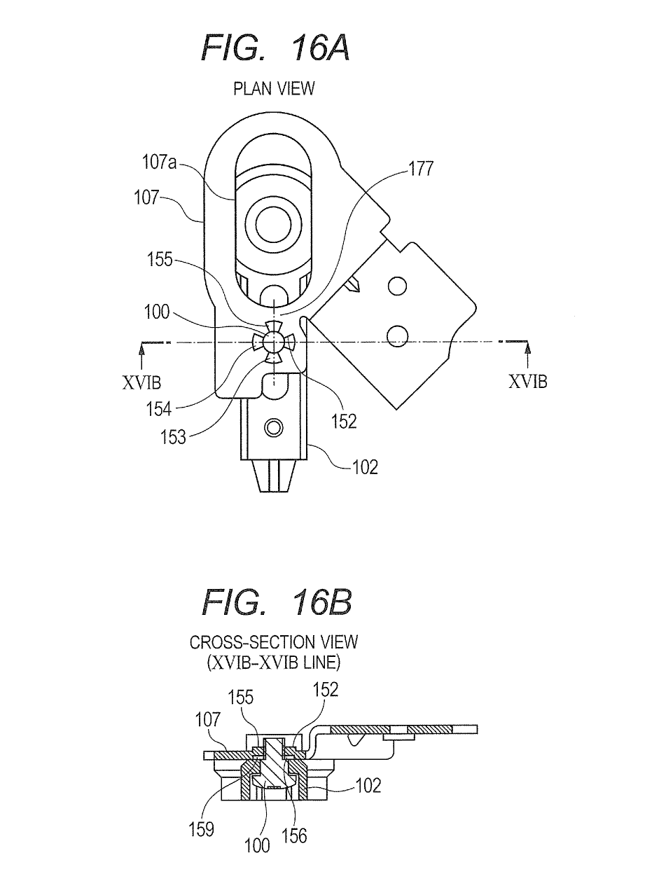

FIGS. 16A and 16B are a plan view and a cross-section view illustrating a part of the ITB unit of the image forming apparatus, which illustrate half-pierce burring according to a third embodiment of the present invention. When a bearing surface does not match with a fastening surface in the case of three directions, the half-punched portions may be provided at four locations so as to obtain stable stress distribution on the bearing surface and improve the strength in vertical and lateral directions.

As described with reference to FIGS. 2A, 2B, and 3, not only the stress of the shoulder screw 100 but also the stress of the transfer rear side plate 107 is applied to the tension roller bushing 102, and a force acts the inside so as to cause a warp of the screw fastening-side plane 177. In a case where a strong spring force is set or the reaction force is large, the transfer rear side plate 107 may be deformed and the screw fastening-side plane may be warped.

As reinforcement to address this problem as much as possible, a bisector of the half-punched shapes 155 and 153 is directed in a sliding vertical direction of the tension roller bushing 102 in the direction of the transfer roller guide hole 107a. Further, the half-pierce burring in which the screw falling in the sliding lateral direction can be prevented and the half-punched portions are radially and equiangularly arranged is employed, and hence it is possible to provide a structure that is capable of not only dealing with the force to be applied to the threaded portion from the outside, but also reinforcing the thin plate member itself.

### Fourth Embodiment

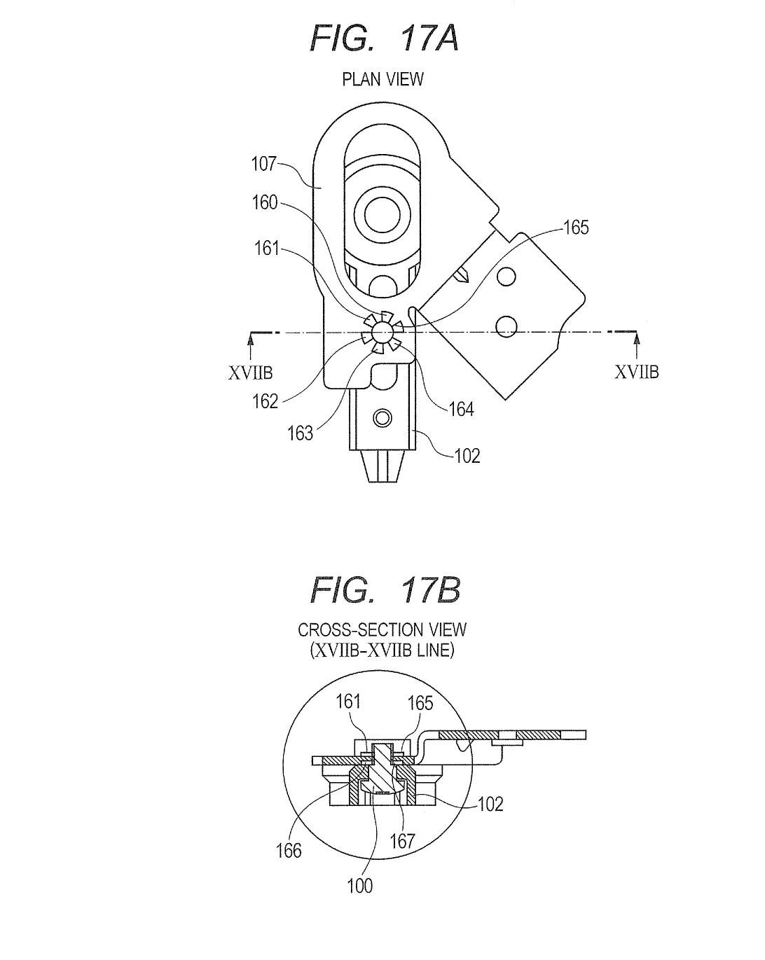

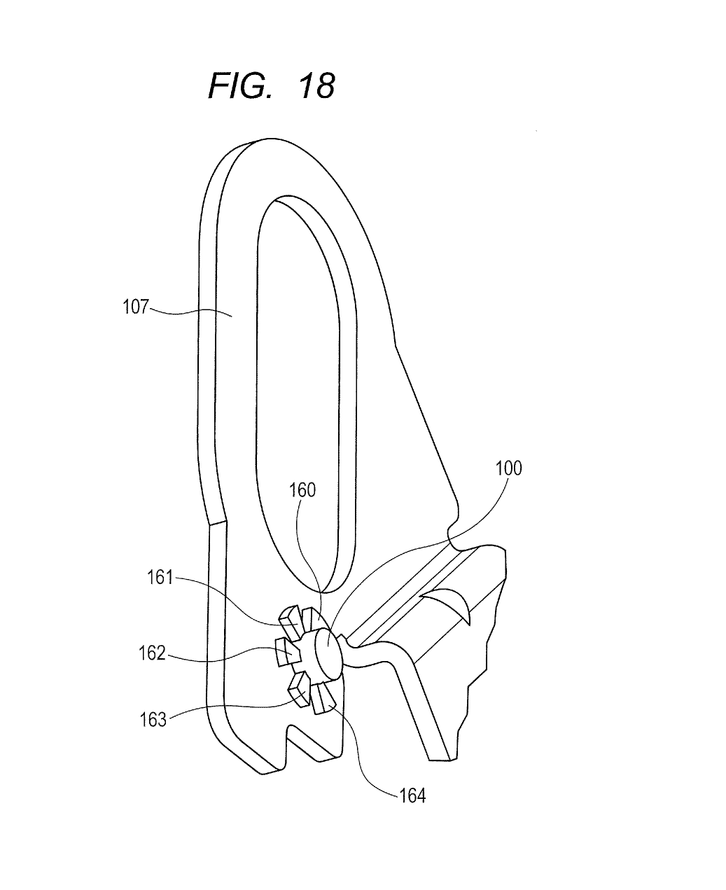

FIGS. 17A, 17B, and 18 illustrate a fourth embodiment of the present invention. FIGS. 17A and 17B are a plan view and a cross-section view illustrating a part of the ITB unit of the image forming apparatus, which illustrate half-pierce burring according to the fourth embodiment. FIG. 18 is an enlarged perspective view of a part of the ITB unit of the image forming apparatus, which illustrates the half-pierce burring according to the fourth embodiment.

FIGS. 17A, 17B, and 18 illustrate a feature in that protruding and recessed shapes 160, 161, 162, 163, 164, 165, 166 and 167 are arranged so as to extend radially in six directions from the center of the shoulder screw 100. The outer peripheral portion of the protruding and recessed shapes form a circle that is finely set so as to be larger than the shoulder portion diameter of the shoulder screw. With this, the thread strength at the burring portion is uniformly stable as a whole without considering the directionality. The screw fastening-side plane 177 is brought into contact with the abutment bearing surface of the shoulder screw at six points, and hence it is possible to provide half-pierce burring in which the screw is fastened in a further perpendicular and accurate manner and is less liable to be loosened after being fastened.

The radial shape can be broken down more finely, but as the radial shapes are broken down more finely, the die strength is reduced, and thus the wear damage is increased. To address this problem, the step as the half-punched amount can be reduced, but there arises a new problem in that the strength required for fastening the screw, which is the original goal to be achieved, cannot be satisfied. In order to address this problem, a replaceable pierce burring die using an insert as the die set may be employed, but the die becomes complicated and expensive in this case. Therefore, it can be said that about six directions are appropriate.

### Fifth Embodiment

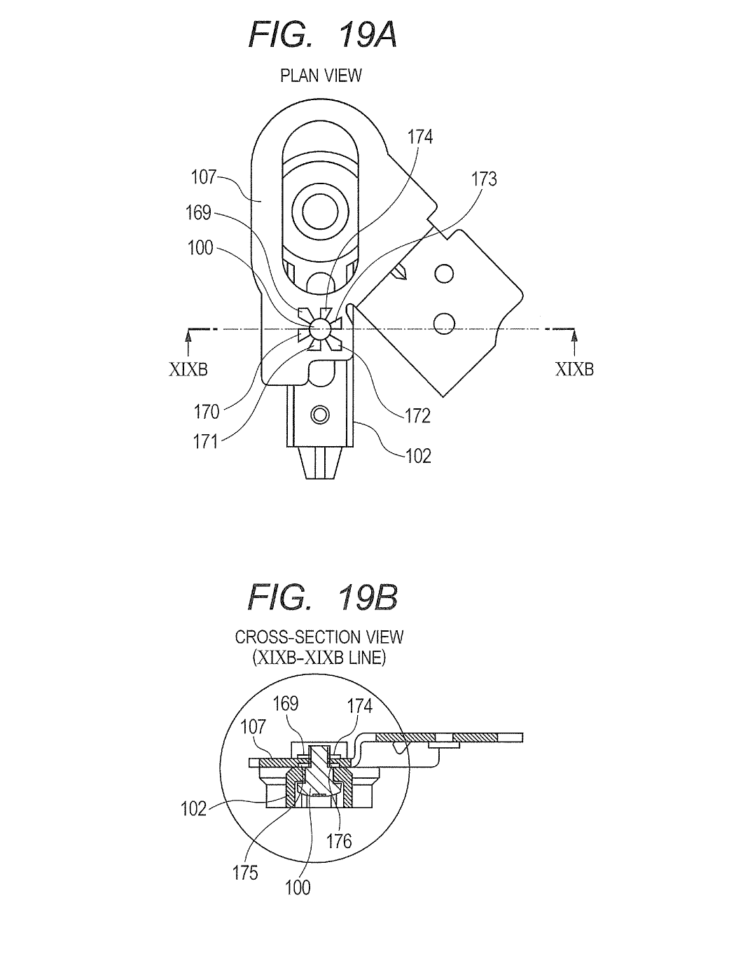

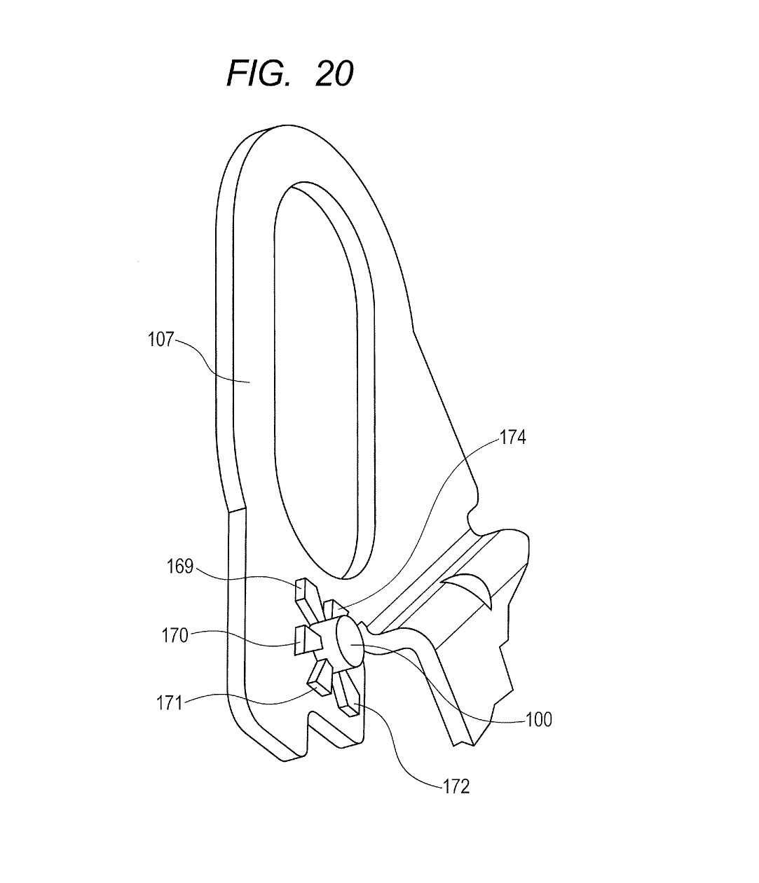

FIGS. 19A, 19B, and 20 illustrate a fifth embodiment of the present invention. FIGS. 19A and 19B are a plan view and a cross-section view of a part of the ITB unit of the image forming apparatus, which illustrate half-pierce burring according to the fifth embodiment. FIG. 20 is an enlarged perspective view of a part of the ITB unit of the image forming apparatus, which illustrates the half-pierce burring according to the fifth embodiment.

FIGS. 19A, 19B, and 20 illustrate half-pierce burring having protruding and recessed shapes which are radially extend in six directions from, as a reference, the center of the shoulder screw 100 similarly to the above. In the fourth embodiment, the outer periphery has a round shape. This embodiment has a feature in that the outer shape is not round but rectangular. That is, stepped portions 169 to 174 form a rectangular shape whose center is the through hole 115, and are formed in an area that is equal to or larger than the diameter of the shoulder portion of the shoulder screw 100. Because the rectangular shape is employed, the bearing area for the tension roller bushing 102 may be increased to secure a wide area through further extension, and the strength of the entire surface can be improved in a wide range.

The protruding and recessed shapes are asymmetric in the front-rear moving direction of the sliding direction, and hence there is a feature in that abrasion at one location can be suppressed. For example, in order to obtain smooth movement of a member that slides in a slot hole direction around the shoulder screw, grease or the like is applied as a lubricant agent in some cases.

At this time, an oil sump may be formed in each radial half-punched portion, and thus an additional feature in that oil lacking is prevented can be provided to achieve improvement in abrasion resistance. Further, it is possible to obtain such an effect that stable operation can be secured even in long-term use.

As another usage method, when the present invention is adopted to a screw fastening location at a part of the printed circuit board, such as an earth pattern and a land (part at the terminal of a copper foil pattern in the printed circuit board; conducive portion), multipoint contact becomes possible, and hence an effect of improving the conductivity can be obtained.

When a sliding contact is provided to a metal movable portion, there is known that, in the case of one point contact, contact failure may be caused due to dust, contamination, and the like. In the case of contact of six points or more, at least one of the contacts is effective, and hence contact failure hardly occurs. Therefore, the half-pierce burring having a protruding and recessed surface and a sufficient screw fastening force can be suitably employed for fixation of the printed circuit board.

As described above, the present invention has a feature in that the half-punched portions of the thin metal plate form a round shape or a rectangular shape around the screw hole as a center, and the half-punched portions are formed in an area that is equal to or larger than the diameter of the shoulder portion of the shoulder screw. With this, it is possible to provide half-pierce burring in which not only the strength of the threaded portion is increased, but also the strength around the bearing surface can be improved.

As described above in the embodiments, it is possible to provide half-pierce burring in which the two to six contact positions, which are in the same plane of the stepped portion of the half-punched portion of the thin plate member, are brought into contact with the shoulder screw which may be selected to achieve respective characteristics thereof.

Further, it is possible to provide half-pierce burring in which the screw hole passing through the thin plate member serving as the fastening member made of a metal material is formed by any one of cutting tap processing, forming tap processing, and a self-tap screw processing to enable screw fastening.

The present invention has been described with use of the shoulder screw 100. However, even in a case where a fastening member having a thickness that can cancel the distance of the incompletely threaded portion of a thick plate portion is fastened with a general screw, the present invention can be adopted as in the case of the conventional burring. In this case, the number of processing steps can be reduced, and hence it is possible to obtain such effects that a simple die can be used and the number of steps for pressing can be reduced.

Further, piercing and half-piercing can be performed by the same die, and hence an effect of, for example, improvement in quality and in easiness of maintenance may be synergistically achieved.

The effects of the structures of the above-mentioned first to fifth embodiments may be summarized as follows.

1) In the structure of fastening a screw to the thin plate member serving as the fastening member made of a metal material, the stepped portion formed in the thin plate member by half punching is radially formed from the center of the screw hole so as to be recessed and protruded alternately in the circumferential direction. The threaded portion is formed in the screw through hole provided at a substantially center position of the half-punched shape by tapping, and the member to be fastened is fastened to the thin plate member with a screw. With this screw fastening structure, a drawing droop surface is not formed due to burring, and hence the amount of the incomplete thread is reduced.

As a result, the length of the complete thread shape is increased, and hence the thread engagement amount increases. Thus, the breaking strength is increased, which contributes to improvement of the fastening force. In addition, damage is less applied to the threaded portion when the screw is repeatedly fastened and disengaged, and thus repeated use is possible in a larger number of times.

2) A radial half-punched or half-pierced shape (in the field of a press die, a shape obtained by punching performed by a pierce punch is called “pierced shape”) is provided, which can increase the moment of inertia of area of the thin plate member around the screw due to the protruding and recessed shapes, as compared to the case where tapping is performed with respect to a plane. Therefore, it is possible to obtain such an effect that a sufficient screw fastening force can be obtained.

Measurement was performed by experiments with use of an electrolytic zinc-coated steel sheet (SECC-SD) as a material. In a conventional case of M3 cutting tap processing in a plate having a thickness of 1.2 mm, the threaded portion was possible to withstand the fastening torque of up to 0.7 N·m, and the threaded portion was damaged at 0.8 N·m.

As in the present invention, a similar 1.2 mm-plate was subjected to half-pierce burring so as to be divided in three directions. The half punching amount was set to 0.4 mm, and forming tap processing was performed for a thickness of 1.6 mm in total. In this case, it was possible to obtain such a result that the threaded portion withstood the fastening torque of more than 1.2 N·m. As described above, it was possible to obtain such an experiment result that the screw fastening force was increased by half-pierce burring.

3) A structure of fastening the member to be fastened to the thin plate member with a screw is as follows. The structure includes the thin plate member serving as the fastening member made of a metal material and the movable member to be fastened that is to be fitted and fastened to the thin plate member with a shoulder screw. The shoulder screw is inserted from the half-punch recessed side on the opposite side, and fastened so as to be directed in a direction of the protruding portion obtained through half punching. Further, a screw inserting portion of the thin plate member that abuts against the abutment bearing surface 126 of the shoulder screw forms a substantial edge, to thereby fasten the member to be fastened to the thin plate member with the shoulder screw. With this structure, the fastening can be performed in a smaller area, and the diameter of the screw abutment area of the shoulder screw can be reduced. Therefore, it is possible to construct a structure with a movable part while saving the space.

The shoulder screw having no incomplete thread is applied, which prevents the screw from being damaged at the incomplete thread in the thread root part at the time of fastening. With this, the screw can be prevented from being squeezed inside. Therefore, it is possible to obtain such effects that the shoulder portion can secure its height accurately, and the fitting state of the movable member to be fastened is not inhibited.

4) The half-punched portion forms a round shape or a rectangular shape around the screw hole as a center, and the half-punched portion is formed in an area that is equal to or larger than a diameter of the shoulder portion of the shoulder screw. In this manner, even when forces are applied from different directions when the screw is fastened, the plane at the screw fastening portion is formed tough, and hence there is no fear of deformation.

It is possible to form half-punched protruding and recessed shapes having a radial multi-divided and rectangular shape (rectangular shape in which the half-punched shape serving as the protruding and recessed surface is radially formed around the screw hole as the center, and the outer shape thereof follows the sides forming a substantially rectangular shape when the screw hole is viewed from the front side). With this, it is possible to obtain such an effect that the thread strength and the surface strength can be effectively increased in a narrow space.

In this case, the thread strength refers to the strength at which the crest and root contacting portion between the male thread and the female thread does not break when the screw is tightened with a screwdriver. Strength refers to a concept representing a material mechanical property or the like, and is an index representing the deformation behavior when a stress is applied to the material. The strength refers to a strength at which a planar portion of the material can withstand a moment in terms of the strength of materials, and can be represented by an elastic limit. The surface strength is defined by a limit load at which the material can recover to the original state when the screw is fastened and loosened again, and may be correlatively compared with a fastening torque.

5) There are two to six contact positions in the same plane of the stepped portion of the half-punched portion of the thin plate member. Thereby, the shoulder screw can be stably mounted, and die pressing can be performed in the lowest number of steps, that is, one or two steps.

6) The screw hole passing through the thin plate member serving as the fastening member made of a metal material is formed by cutting tap processing, forming tap processing, or self-tapping screw processing. The passing through screw hole to be fastened with the screw is formed, and thus, the cutting tap processing can be performed in the subsequent step. Besides, it is possible to obtain such an effect that two types of the forming tap and the self-tapping screw, which require the same prepared hole diameter, can be freely selected.

Cutting tap processing refers to processing that is performed with use of a tool called a cutting tap. The cutting tap has grooves provided in its lateral surface as clearances for guiding the chips left after the cutting. Forming tap processing uses a thread tapping tool having a shape in which the leading end is pointed and the thickness gradually increases, to thereby cause plastic deformation of the prepared hole to form the thread.

In general, a screw is directly fastened to a matching screw hole that is obtained by subjecting the prepared hole to helical tapping in advance. The self-tapping screw is a screw having a function of a forming tap with respect to a predefined straight cylindrical prepared hole, and is configured to form a thread in the prepared hole through plastic deformation so that the screw can be directly fastened.

A prepared hole refers to a hole that is formed in advance, and is defined based on a thread tapping tool. In the case of an M3 thread (metric coarse thread), the prepared hole diameter is defined as 2.459 mm by Japanese Industrial Standards (JIS) and International Organization for Standardization (ISO).

As described above, it is possible to provide a high-strength screw fastening structure which enables repeated use with respect to the thin plate member, which has originally caused a trouble in a shoulder screw and burring.

According to the present invention, the strength of the fastening member is increased by half punching, and hence without devising the shape of the member to be fastened, a screw can be fastened with a sufficient fastening force. Other members such as a self-locking nut are unnecessary, and hence it is possible to provide screw fastening burring means for a thin plate, which is capable of energy saving and reducing cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-212150, filed Sep. 26, 2012 which is hereby incorporated by reference herein in its entirety.

1. A screw fastening structure, comprising:
a plate member serving as a fastening member;
a screw hole portion provided in the plate member, the screw hole portion having a helical portion on an inner surface thereof to fasten a screw;
a plurality of sheared portions shearing a part of an edge of the screw hole portion in a same direction with respect to a thickness direction of the plate member at different positions in a circumferential direction of the screw hole portion; and
a recessed portion formed in a periphery of the screw hole portion by the plurality of sheared portions.

2. A screw fastening structure according to claim 1, wherein the recessed portion is formed radially from a center of the screw hole portion so as to have a plurality of recesses in a circumferential direction of the screw hole portion.

3. A screw fastening structure according to claim 1, further comprising a shoulder screw to be inserted into and fastened to the screw hole portion, the shoulder screw being inserted and fastened so as to be directed in a direction toward a bottom surface of the recessed portion.

4. A screw fastening structure according to claim 3, wherein a screw inserting portion for a member to be fastened of the plate member which abuts against an abutment bearing surface of the shoulder screw forms a substantial edge, and the member to be fastened is fastened to the plate member with the shoulder screw.

5. A screw fastening structure according to claim 3, wherein a stepped portion is formed in an area that is equal to or larger than a diameter of a shoulder portion of the shoulder screw.

6. A screw fastening structure according to claim 1, wherein there are at least two contact positions in the same plane as a stepped portion.

7. A screw fastening structure according to claim 1, wherein the screw hole portion is formed by any one of cutting tap processing, forming tap processing, and self-tapping screw processing.

8. (canceled)

9. A processing method of a screw fastening structure, comprising:
forming a screw hole portion in a fastening member; and
deforming a part of an edge of the screw hole portion in a same direction with respect to a thickness direction of the fastening member by using a shear force at different positions in a circumferential direction of the screw hole portion.

10. A screw fastening structure according to claim 1, wherein a step of the recessed portion is smaller than a thickness of the plate member.
